(19) United States
(12) Patent Application Publication
(10) Pub. No.: US 2026/0160290 A1
(43) Pub. Date: Jun. 11, 2026

(54) SECURING ARRANGEMENT OF A SECURING RING FOR A MOTOR VEHICLE, AND A MOTOR VEHICLE

(71) Applicant: MERCEDES-BENZ GROUP AG, Stuttgart (DE)

(72) Inventors: Patrik SZOELLOESI, Stuttgart (DE); Dennis WINTER, Stuttgart (DE)

(21) Appl. No.: 18/880,887

(22) PCT Filed: Jun. 7, 2023
(86) PCT No.: PCT/EP2023/065267

§ 371 Date: Jan. 3, 2025

(30) Foreign Application Priority Data
Jul. 7, 2022 (DE) 10 2022 002 486.1

(51) Int. Cl. F16B 21/18

(52) U.S. Cl. CPC F16B 21/186

(57) ABSTRACT

A securing arrangement of a securing ring on a first component and a second component for a motor vehicle include the securing ring being partially arranged in an outer circumferential groove of the first component. The securing ring is bent, at its two free ends opposite each other, in the same direction extending in an axial direction of the securing ring. The two free ends of the securing ring engage in the axial direction of the securing ring into respective first axial pockets of the first component. The two free ends of the securing ring engage in the axial direction of the securing ring into respective second axial pockets of the second component.

### BACKGROUND AND SUMMARY OF THE INVENTION

Exemplary embodiments of the invention relate to a securing arrangement of a securing ring on a first component and a second component for a motor vehicle, as well as to an automobile having at least one such securing device.

DE 10 2019 121 294 A1 discloses a securing ring for a radial groove in a coupling device, wherein the radial groove is formed by axially extending fingers that are bent radially inwards at their free ends and form the radial groove for the securing ring there.

Exemplary embodiments of the present invention are directed to a securing arrangement of a securing ring on a first component and a second component for a motor vehicle, as well as a motor vehicle having at least one such securing arrangement so that a particularly large range of functions can be realized.

A first aspect of the invention relates to a securing arrangement of a securing ring on a first component and a second component for a motor vehicle, in particular for an automobile, preferably designed as a passenger car. This means that the motor vehicle designed preferably as an automobile, in particular as a passenger car, and simply referred to as a vehicle, in its completely produced state has the securing arrangement and thus the securing ring, the first component and the second component. More preferably, the first component and the second component are components of a coupling device, in particular a coupling, of the motor vehicle. More particularly, the securing ring and the components are elements of a claw brake, by means of which, for example, a planetary carrier of a planetary gear set can be rotationally fixed, in particular in a form-fitting manner, to a housing and thus can be secured against rotation in relation to the housing.

In the securing arrangement, the securing ring is partially arranged in an outer circumferential groove of the first component. This means that a first subsection of the securing ring is arranged, in particular, in a radial direction of the securing ring in the groove of the first component. A second subsection, adjoining the first subsection in particular in the radial direction of the securing ring, in particular towards the outside, of the securing ring is arranged outside the groove and therefore protrudes out of the groove, so that the securing ring partially protrudes out of the groove. The feature that the groove of the first component is an outer circumferential groove of the first component is, in particular, to be understood that the groove is provided, in particular made, on an outer circumference of the first component. Thus, for example, the groove is a groove, i.e., a cavity in an outer circumferential lateral surface of the first component, so that the groove is open outwards for example in a radial direction of the securing ring and thus in the radial direction of the components. The groove is also referred to as a radial groove or is designed as a radial groove. In particular, the groove extends in a circumferential direction, extending around the axial direction of the securing ring and thus of the components, completely enclosing the first component.

The securing ring has two free ends, in particular exactly two free ends that are opposite each other, in particular in a circumferential direction of the securing ring extending around the axial direction of the securing ring. In particular, the free ends are spaced apart from each other, in particular in the circumferential direction of the securing ring. The securing ring is bent, at its two free ends opposite each other, in the same direction extending in an axial direction of the securing ring. In other words, the free ends are bent or turned up in the same axial direction. The feature that the direction extends in an axial direction of the securing ring is to be understood to mean that the direction extends parallel to the axial direction of the securing ring or coincides with the axial direction of the securing ring.

The two free ends of the securing ring engage, in particular as a result of being bent or turned up axially, in an axial direction of the securing ring into respective, first axial pockets of the first component. In particular, the first pockets of the first component are arranged in an axial direction of the securing ring and thus of the components next to the groove, i.e., arranged laterally to the groove, so that the first pockets in an axial direction follow on from the groove or adjoin the groove. The respective first pocket is limited in the circumferential direction of the securing ring and thus in the circumferential direction of the components, in particular on both sides, by respective first walls of the first component, designed in particular as a solid body and preferably inherently rigid, so that the free ends can be or are supported in the circumferential direction of the securing ring on at least two of the first wall portions. As a result, a relative rotation between the securing ring and the first component can be avoided or at least limited, and in particular both in a first rotation direction, extending around a rotational axis, as well as in a second rotation direction, opposed to the first rotation direction and extending around the rotational axis. This is achieved in particular by, for example, one of the free ends being or being able to be supported in the first rotation direction on one of the first wall portions of one of the first pockets, and the other end being or being able to be supported in the second rotation direction on one of the first wall portions of the other of the first pockets. The circumferential direction of the securing ring extends around the rotational axis, and the rotational axis extends in the axial direction of the securing ring, wherein, for example, the rotational axis coincides with the axial direction of the securing ring or extends parallel to it.

In the securing arrangement according to the invention, the two free ends of the securing ring engage in the axial direction of the securing ring and thus of the components into respective second axial pockets of the second component, whereby a relative rotation between the securing ring and the second component around the rotational axis is also avoided or at least limited. The previous and following embodiments relating to the first pockets can also be readily transferred to the second pockets, so that, for example, the respective second pocket is bounded in the circumferential direction of the securing ring and thus of the components, in particular on both sides, by respective second wall portions of the second component, which are designed in particular as solid bodies and are preferably dimensionally stable, i.e., inherently rigid. Thus, for example, the one free end of the securing ring can be or is supported in the first rotation direction on one of the second wall portions of one of the second pockets, and the other free end of the securing ring can be or is supported in the second rotation direction on one of the second wall portions of the other of the second pockets. Since the free ends engage into the first pockets of the first component and into the second pockets of the second component, relative rotations between the components around the axis of rotation are also avoided or limited. The aforementioned rotational axis extends in the axial direction of the securing ring, wherein the rotational axis coincides in particular with the axial direction of the securing ring. Furthermore, the components are secured axially, i.e., in the axial direction of the securing ring, against each other or relative to each other by means of the securing ring, so that axial relative movements, i.e., relative movements between the components in the axial direction of the securing ring, are avoided or at least limited by means of the securing ring. A particularly large range of functions can be realized by the invention. Firstly, an axial securing of the components can be achieved, with, for example, the second component being secured axially to the first component by means of the securing ring or vice versa. Secondly, the securing ring itself is secured against rotation, both in relation to the first component and in relation to the second component. Furthermore, the components are secured against each other or relative to each other by means of the securing ring. This large range of functions can therefore be realized without radial thickening of the securing ring, since the securing ring does not engage in a radial direction into cavities but engages in an axial direction into the mentioned pockets.

The second component is, for example, arranged radially outside the first component. For example, the second component has an inner radius that is smaller than an outer radius of the securing ring. The first pockets and the second pockets are axially directed or orientated. This means that the respective pocket is an axial cavity, i.e., a cavity extending in an axial direction, into which the respective end engages axially, i.e. in an axial direction of the securing ring. The invention is thus based in particular on the following findings and considerations: When using securing rings, for example in coupling devices, conventional solutions can cause the securing ring to rotate tangentially, i.e., in the circumferential direction of the securing ring, due to high rotational speeds and the resulting centrifugal forces, particularly relative to the components that are axially secured to each other by means of the securing ring. This can lead to an increased wear due to incorporating the securing ring into the groove, in particular into the groove geometry thereof. This influence has negative effects on the service life, which is why this tangential rotation of the securing ring in relation to the first component having the groove is to be avoided. Typically, excessive rotation of the securing ring in relation to the first component having the groove is solved by the securing ring having an anti-rotation mechanism comprising at least one change in cross-section of the securing ring over the circumference thereof. In a counterpart, i.e., in the first component having the groove, in which the securing ring is partially arranged, the groove depth has to be partially increased for this purpose. A disadvantage of this anti-rotation mechanism is, however, that the groove requires more radial installation space in order to realize the anti-rotation function compared to solutions omitting the anti-rotation mechanism, but if no corresponding countermeasures are taken, this can lead to undesired rotation of the securing ring in relation to the first component.

The aforementioned problems and disadvantages can be avoided by the invention. Firstly, the invention makes it possible to avoid undesired relative rotations between the components and between the securing ring and the first component and between the securing ring and the second component. This can be realized by the ends engaging into the axial pockets, whereby the securing ring is secured against rotation both with respect to the first component and with respect to the second component, and whereby the first component is secured against rotation with respect to the second component or vice versa. This anti-rotation mechanism can be realized without requiring excessive radial installation space, as changes in the cross-section of the securing ring over its circumference and a partial groove depth increase of the groove can be avoided. In other words, the large range of functions can be realized without an increase in radial installation space, as in the case of a securing ring without an anti-rotation mechanism.

In order to be able to avoid excessive relative rotation between the securing ring and the respective component and between the components in a particularly reliable manner, it is provided in one embodiment of the invention that the securing ring is bent by at least or exactly 10° at its two opposite free ends in the same direction extending in the axial direction of the securing ring. In other words, it is preferably provided that the free ends are bent or turned up in the same axial direction by at least or exactly 10°.

The invention is an efficient method to reduce radial installation space and simultaneously secure the securing ring and the components against tangential movements, i.e., against rotations.

Preferably, the securing ring is formed from a metallic material, in particular from a steel. Furthermore, it is preferably provided that the securing ring is designed as one piece. In other words, the securing ring is preferably formed as an individual piece, so that the securing ring is formed by a monobloc or designed as a monobloc. In other words, the securing ring is preferably designed as an integral body, i.e., as an integrally produced or designed body.

A further embodiment is characterized in that the first component is a sliding sleeve for the aforementioned claw brake of a gear device of the motor vehicle, wherein the second component is an actuating piston for the sliding sleeve or a connecting element between the sliding sleeve and the actuating piston. In particular it is conceivable that the sliding sleeve is connected to the actuating piston by means of the connecting element. As a result, a particularly effective and efficient securing can be realized.

It has proven to be particularly advantageous when the actuating piston and the connecting element are designed as one piece with each other. In other words, it is preferably provided that the actuating piston and the connecting element are formed from an individual piece, so that the actuating piston and the connecting element are not composed of parts that are designed separately from each other and connected to each other, but rather the actuating piston and the connecting element are designed as a monobloc or formed by a monobloc. Therefore, the installation space requirement can be kept particularly low.

In order to be able to realize a particularly efficient and effective anti-rotation means in a particularly cost-effective manner, it is provided in a further embodiment of the invention that the connecting element and the actuating piston are designed separately from each other and are connected in a rotationally fixed manner to each other. Furthermore, the connecting element and the actuating piston are connected to each other so as to be immovable relative to each other in the axial direction of the securing ring, i.e., connected fixedly to each other, so that axial relative movements between the connecting element and the actuating piston are avoided or prevented.

In a further, particularly advantageous embodiment of the invention, the first component has, on its outer circumference, a bridge extending, in particular completely, in the circumferential direction of the first component, which bridge extends away, for example, in a radial direction outwards from the groove or from a surface region adjoining the groove and/or the bridge. For example, the bridge adjoins the groove in the axial direction. In particular it is conceivable that the first pockets are formed in the bridge. As a result, a cost-effective and easy-to-install and axially shiftably fixed connection between the sliding sleeve and the actuating piston or the connecting element can be achieved.

For example, a magnet, in particular a permanent magnet, can be provided on the actuating piston or the connecting element for detecting an axial position of the actuating piston or the connecting element, wherein the magnet certainly does not rotate away from a sensor field of a sensor for detecting the magnet during operation, so that signal detection is always possible.

In order to be able to realize excessive relative rotations in a particularly cost-effective manner, it is provided in a further embodiment of the invention that the securing ring is formed of a rod section with a constant cross-section.

A second aspect of the invention relates to a motor vehicle, preferably designed as an automobile, in particular as a passenger car, which has at least one securing arrangement according to the first aspect of the invention. Advantages and advantageous embodiments of the first aspect of the invention are to be regarded as advantages and advantageous embodiments of the second aspect of the invention and vice versa.

Further advantages, features and details of the invention can be seen from the following description of a preferred exemplary embodiment and with reference to the drawing(s). The features and combinations of features mentioned above in the description as well as the features and combinations of features mentioned below in the description of the figures and/or shown alone in the figures can be used not only in the combination indicated in each case, but also in other combinations or on their own, without leaving the scope of the invention.

### BRIEF DESCRIPTION OF THE DRAWING FIGURES

The drawing shows in:

FIG. 1 a schematic perspective view of a securing arrangement of a securing ring on a first component and a second component;

FIG. 2 in part another schematic perspective view of the securing arrangement;

FIG. 3 in part a schematic and sectioned perspective view of the securing arrangement;

FIG. 4 in part another schematic perspective view of the securing arrangement;

FIG. 5 a schematic perspective view of the securing ring;

FIG. 6 in part a schematic perspective view of the securing ring;

FIG. 7 a schematic plan view of the securing ring; and

FIG. 8 a schematic and sectioned side view of the securing ring.

In the figures, identical or functionally identical elements are provided with the same reference signs.

### DETAILED DESCRIPTION

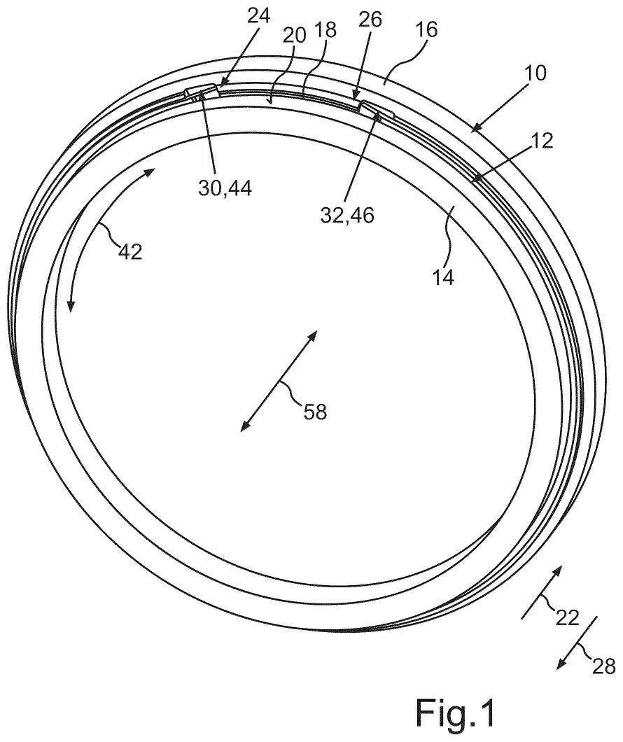

FIG. 1 shows, in a schematic perspective view, a securing arrangement 10 of a securing ring 12 on a first component 14 and a second component 16 of a motor vehicle, designed preferably as an automobile, in particular as a passenger car. The motor vehicle is simply also referred to as a vehicle. For example, the securing ring 12 and the components 14 and 16 are elements of a gear device, in particular of a coupling device of the gear device, designed for example as a claw brake.

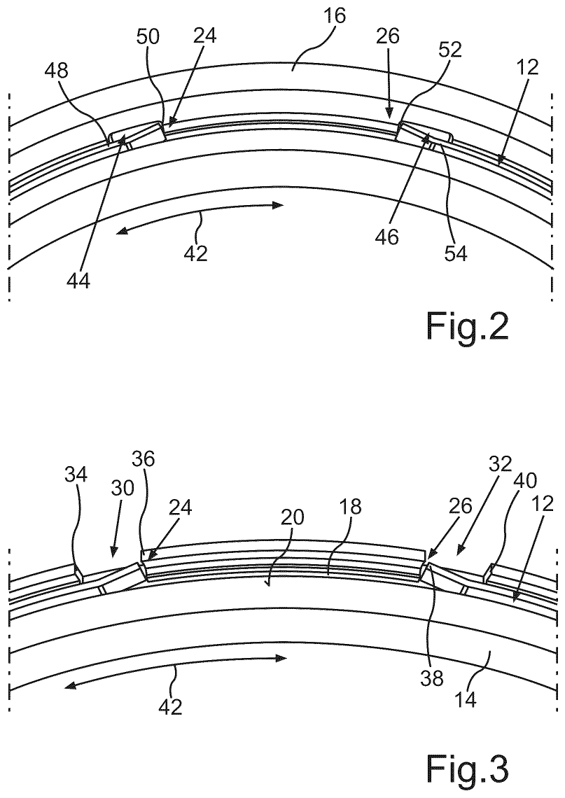

It can be seen particularly well in an overview with FIGS. 2 and 3 that the securing ring 12 is arranged partially in the securing arrangement 10 in a groove 18, also referred to as a radial groove or designed as a radial groove, of the first component 14, wherein the securing ring 12 partially protrudes outwards along its radial direction and in particular in a radial direction of the securing ring 12 out of the groove 18 and thus out of the component 14. This means that a first subsection of the securing ring 12 engages into a groove 18 in a radial direction of the securing ring 12 and thus of the components 14 and 16, i.e., is arranged in the groove 18. A second subsection of the securing ring 12 is arranged outside the groove 18 and protrudes outwards, in particular, in a radial direction of the securing ring 12 out of the groove 18 and thus out of the component 14.

Axial relative movements between the securing ring 12, simply also referred to as a ring, and the component 14 are at least restricted or avoided because the securing ring 12 is partially arranged in the groove 18. The axial relative movements between the securing ring 12 and the component 14 are understood as relative movements between the ring and the component 14 occurring in an axial direction of the securing ring 12 and thus of the components 14 and 16. The groove 18 extends completely around the component 14 in the circumferential direction of the securing ring 12 and thus of the components 14 and 16 that extends around the axial direction of the securing ring 12 and thus of the components 14 and 16. It can be seen that the groove 18 is formed in an outer circumferential lateral surface 20 of the component 14 and thus is provided on an outer circumference of the component 14. At least one subsection of the second component 16 is overlapped by the securing ring 12, in particular by the second subsection of the securing ring 12, at least in a direction that is illustrated by an arrow 22 in FIG. 1 and extends in an axial direction of the securing ring 12 and the components 14 and 16, whereby axial relative movements between the components 14 and 16 are avoided or at least restricted, at least in the direction illustrated by the arrow 22. This means that an axial securing of the components 14 and 16 against each other is realized by means of the securing ring 12.

As can be seen particularly well from FIGS. 2 to 8, the securing ring 12 is bent at its two free ends 24 and 26, which are opposite each other in the circumferential direction of the securing ring 12 extending around the axial direction of the securing ring 12 and the components 14 and 16, in the same direction extending in the axial direction of the securing ring 12, illustrated in FIG. 1 by an arrow 28 and also referred to as the bending direction, the bending direction being opposite to the direction illustrated by the arrow 22. It can be seen from FIGS. 2 and 3 that in an axial direction of the securing ring 12 and thus of the components 14 and 16, the free ends 26 engage into respective first axial pockets 30 and 32 of the first component 14. When the axial direction is referred to in the following, it is understood to mean the axial direction of the securing ring 12 and thus of the components 14 and 16, unless otherwise specified.

It can be seen that the pocket 30 is bounded in a circumferential direction of the securing ring 12 and thus of the components 14 and 16 on both sides by wall portions 34 and 36 of the component 14. The pocket 32 is bounded in a circumferential direction of the securing ring 12 on both sides by respective wall portions 38 and 40 of the component 14. The circumferential direction of the securing ring 12 and of the components 14 and 16 extends around the axial direction and for example is illustrated in FIG. 2 by a double-headed arrow 42.

It can be seen that the free end 24 can be or is supported in a first rotational direction, extending in a circumferential direction of the securing ring 12, in particular directly on the wall portion 36. In a second rotation direction, opposing the first rotation direction and extending in the circumferential direction of the securing ring 12, the free end 26 of the securing ring 12 can or is supported, in particular directly, on the wall portion 38. Therefore, both in the first rotation direction and in the second rotation direction, relative rotations between the securing ring 12 and the component 14 around a rotational axis coinciding with the axial direction can be avoided.

For example, it can be seen from FIG. 2 that the free ends 24 and 26 furthermore engage in an axial direction into respective second axial pockets 44 and 46 of the second component 16. The axial pocket 44 of the component 16 is bounded in a circumferential direction of the securing ring 12 on both sides by respective wall portions 48 and 50 of the component 16. The pocket 46 of the component 16 is bounded in a circumferential direction of the securing ring 12 on both sides by respective wall portions 52 and 54 of the component 16. In this case, the free end 24 can be or is supported in the first rotation direction, in particular directly, on the wall portion 50, and the free end 26 can be or is supported in the second rotation direction, in particular directly, on the wall portion 52. Therefore, relative rotations between the securing ring 12 and the component 16 around the rotational axis can also be avoided both in the first rotation direction and also in the second rotation direction. Furthermore, relative rotations occurring around the rotational axis between the components 14 and 16 can be avoided both in the first rotation direction and also in the second rotation direction. The mentioned relative rotations can be avoided in particular in a form-fitting manner, since the free ends 24, 26 engage into the pockets 30, 32, 44 and 46.

In order to be able to avoid the relative rotations particularly effectively and efficiently, the free ends 24, 26 are bent in the bending direction by at least or exactly 10°

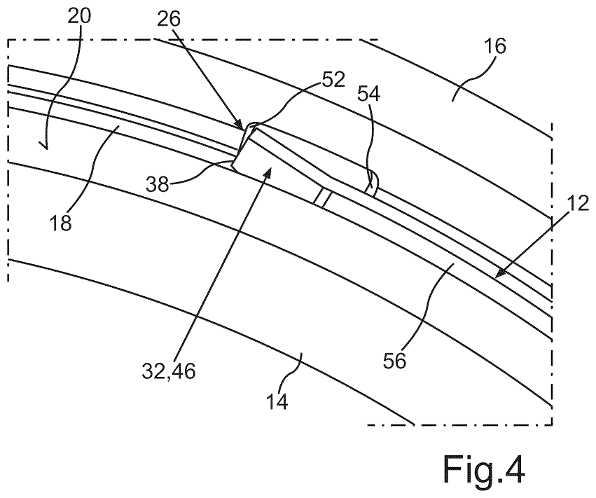

It can be seen particularly well from FIG. 4 that, for example, the free end 26 engages both into the pockets 32 and into the pocket 46. In FIG. 4, the second subsection of the securing ring 12, protruding out of the groove 18, is marked with 56.

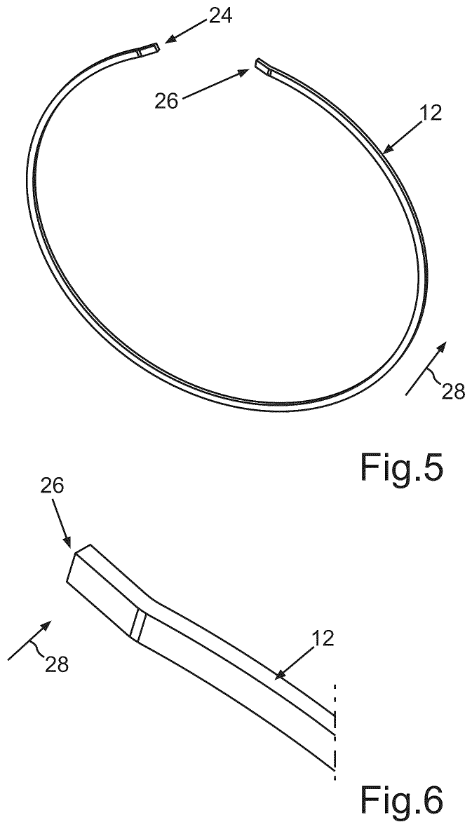

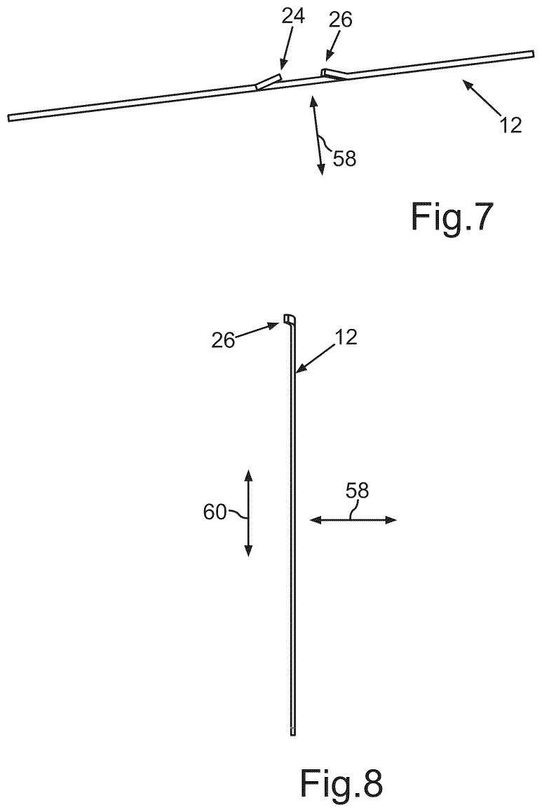

FIG. 5 shows the securing ring 12 in a schematic perspective view. It can be seen particularly well from FIG. 5 that the free ends 24 and 26 are bent in the same direction (bending direction) illustrated by the arrow 28. Furthermore, it can be seen from FIG. 5 that the securing ring 12 is designed as one piece. In particular, the securing ring 12 is formed from a rod section with a constant cross-section. In FIG. 6, the bent free end 26 of the securing ring 12 can be seen. FIG. 7 shows the securing ring 12 in a schematic plan view, in which the ends 26 and in particular the bend thereof can be seen particularly well. Furthermore, in FIG. 7, the axial direction is illustrated by a double-headed arrow 58. The free end 26 can be seen in FIG. 8. The radial direction, extending perpendicular to the axial direction, of the securing ring 12 and thus of the components 14 and 16 is illustrated in FIG. 8 by a double-headed arrow 60. It can be seen particularly well from FIG. 8 that the securing ring 12, in particular the entire securing ring 12, has an in particular constant and, for example, rectangular cross-section.

### LIST OF REFERENCE SIGNS

10 securing arrangement
12 securing ring
14 first component
16 second component
18 groove
20 outer circumferential lateral surface
22 arrow
24 free end
26 free end
28 arrow
30 pocket
32 pocket
34 wall portion
36 wall portion
38 wall portion
40 wall portion
42 double-headed arrow
44 pocket
46 pocket
48 wall portion
50 wall portion
52 wall portion
54 wall portion
56 second subsection
58 double-headed arrow
60 double-headed arrow

1-8. (canceled)

9. A securing arrangement comprising:
a first component for a motor vehicle;
a second component for the motor vehicle;
a securing ring on the first component and the second component,
wherein the securing ring is partially arranged in an outer circumferential groove of the first component,
wherein the securing ring has two free ends opposite each other, wherein the securing ring is bent at the two free ends in a same direction extending in an axial direction of the securing ring,
wherein the two free ends of the securing ring engage in the axial direction of the securing ring into respective first axial pockets of the first component, and
wherein the two free ends of the securing ring engage in an axial direction of the securing ring into respective second axial pockets of the second component.

10. The securing arrangement of claim 9, wherein the securing ring is bent by at least or exactly 10 degrees at its two free ends.

11. The securing arrangement of claim 9, wherein the first component is a sliding sleeve for a claw brake of a gear device, wherein the second component is an actuating piston for the sliding sleeve or a connecting element between the sliding sleeve and the actuating piston.

12. The securing arrangement of claim 11, wherein the actuating piston and the connecting element are one piece with each other.

13. The securing arrangement of claim 11, wherein the connecting element and the actuating piston are produced separately from each other and are connected to each other in a rotationally fixed manner and so as to be immovable relative to each other in the axial direction of the securing ring.

14. The securing arrangement of claim 9, wherein the first component has, on an outer circumference of the first component, a bridge extending in a circumferential direction of the first component.

15. The securing ring of claim 9, wherein the securing ring is formed from a rod section with a constant cross-section.

16. A motor vehicle comprising:
a securing arrangement, which comprises
a first component;
a second component;
a securing ring on the first component and the second component,
wherein the securing ring is partially arranged in an outer circumferential groove of the first component,
wherein the securing ring has two free ends opposite each other, wherein the securing ring is bent at the two free ends in a same direction extending in an axial direction of the securing ring,
wherein the two free ends of the securing ring engage in the axial direction of the securing ring into respective first axial pockets of the first component, and
wherein the two free ends of the securing ring engage in an axial direction of the securing ring into respective second axial pockets of the second component.
